(19) United States
(12) Patent Application Publication
(10) Pub. No.: US 2007/0046213 A1
(43) Pub. Date: Mar. 1, 2007

(54) Organic el laminate type organic switching element and organic el display

(76) Inventor: Kenji Nakamura, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 10/529,759

(22) PCT Filed: Sep. 25, 2003
(86) PCT No.: PCT/JP03/12268

§ 371 Date: Mar. 30, 2005

(30) Foreign Application Priority Data
Sep. 30, 2002 (JP) 2002-285022

(51) Int. Cl. G09G 3/10

(52) U.S. Cl. 315/169.3; 315/169.2

(57) ABSTRACT

It is an object that the number of elements for use in active drive of organic EL element can be reduced, etc. An organic EL laminate type organic switching element according to the present invention has a control electrode (6) provided to which a control signal line for controlling the emission/nonemission condition of the organic EL element part (20) is electrically connected, wherein an organic EL element part (20) and an organic switching element part (30) are laminated on each other.

### TECHNICAL FIELD

The present invention relates to an organic EL laminate type organic switching element and an organic EL display.

### BACKGROUND ART

Some organic EL displays adopt the active matrix drive mode for the purpose of achieving large screen displays. The active matrix drive mode is one in which each organic EL element is made to emit light by independently supplying each pixel with current with the aid of the switching operation of a thin film transistor (TFT: Thin Film Transistor).

As the above described thin film transistor, a MOS type TFT is used which is formed on a semiconductor substrate, the manufacturing process of which requires film formation of inorganic material so that the application of a high temperature process is inevitably involved in the manufacture thereof.

However, the application of a high temperature process raises the manufacture cost of the organic EL displays, and accordingly an organic switching element has been proposed which can be formed at a relatively low temperature (for example, Japanese Patent Laid-Open No. 2000-252550(p. 4, FIG. 3)).

Description is made below of a conventional organic thin film switching element.

FIG. 1 shows a schematic sectional view of an organic thin film switching element as disclosed, for example, in Japanese Patent Laid-Open No. 2000-252550.

In FIG. 1, focusing attention on the fact that electric charge can be directly injected into the organic thin film 104 when a positive or negative voltage is applied to a gate electrode 107 arranged directly on an organic thin film 104, the gate electrode 107 is arranged in a manner sandwiching either a positive hole transport or electron transport organic thin film 104 serving as the channel for the element, and thus either positive holes or electrons are injected into the channel of the organic thin film arranged directly beneath the gate electrode 107.

In an organic thin film switching element 100, when a positive voltage is applied to the positive hole transport organic thin film 104 to generate an electric field, positive holes are injected into the organic thin film 104, and accordingly the positive hole transport organic thin film 104 serves as a channel between metallic electrodes 105 and 106.

Alternatively, when a negative voltage is applied to the electron transport organic thin film 104 to generate an electric field, electrons are injected into the organic thin film 104, and accordingly the electron transport organic thin film between the metallic electrodes 105 and 106 serves as a channel. When current is made to flow under this condition by providing a difference in voltage between the metallic electrodes 105 and 106, namely, the source electrode and drain electrode, taking advantage of the electrons or positive holes injected into the organic thin film as carriers, the thereby caused on/off operation of the gate voltage can make a switching of the current from the source electrode 105 to the drain electrode 106.

In the organic thin film switching element, when charge is injected into the organic thin film channel by applying an on-voltage to the gate electrode 10 7 directly joined to the organic thin film channel, current flows between the opposing metallic electrodes 105 and 106 owing to the injected charge.

When the voltage applied to the gate electrode 107 is turned off, the injected charge fades away and the current vanishes. The control of the organic EL element in the active matrix drive mode does not require the fine control of current on the basis of the gate voltage, and accordingly can be achieved only if there are two organic thin film switching elements capable of current on/off operation.

Such an organic switching element as described above (organic thin film switching element), however, requires at least two transistors and a capacitor for the purpose of actively driving the organic EL element. The use of an organic switching element permits controlling the emission/nonemission condition of the organic EL element, but is hardly capable of displaying gradation.

### DISCLOSURE OF THE INVENTION

It is therefore an object of the present invention to provide an organic EL laminate type organic switching element and an organic EL display in which the number of elements for use in active drive of the organic EL element can be reduced and gradation can be displayed.

The above object of the present invention can be achieved by an organic EL laminate type organic switching element provided with: an organic EL element part and an organic switching element part, wherein the organic EL element part and the organic switching element part are being laminated; and a control electrode which is electrically connected to a control signal line for controlling the emission/nonemission condition of the organic EL element part.

According to the present invention, the number of elements for use in active drive of the organic EL element can be reduced.

In one aspect of the organic EL laminate type organic switching element of the present invention, the control electrode serves both as the cathode of the organic EL element part and as the anode of the organic switching element part.

The above object of the present invention can be achieved by an organic EL display provided with an image plane which is composed of a plurality of pixels, wherein the pixels each have two or more subpixels.

In one aspect of the organic EL display of the present invention, the subpixels have emission areas different from each other.

According to this aspect, gradation can be displayed (represented).

In another aspect of the organic EL display of the present invention, the subpixels each are constructed with an organic EL laminate type organic switching element is provided with an organic EL element part and an organic switching element part, wherein the organic EL element part and the organic switching element part are being laminated; and a control electrode which is electrically connected to a control signal line for controlling the emission/nonemission condition of the organic EL element part.

According to this aspect, the number of elements for use in active drive of the organic EL element can be reduced.

In further aspect of the organic EL display of the present invention, the subpixels each are supplied with control signals different from each other so that the gradation display of the pixel is made possible.

According to this aspect, Combination of the emission/nonemission conditions of the subpixels permits varying the emission area of the whole pixel so that the gradation of the pixel can be displayed.

### BRIEF DESCRIPTION OF THE DRAWINGS

FIG. 1 is a schematic sectional view of a conventional organic thin film switching element.

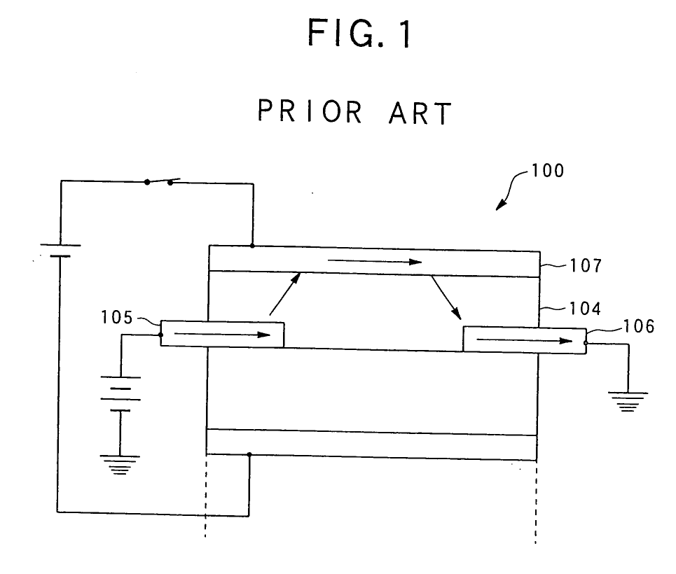

FIG. 2 is a schematic sectional view of an organic EL element laminate type organic switching element involved in an embodiment of the present invention.

FIG. 3 is a graph showing the current-voltage characteristics of the organic EL laminate type organic switching element involved in an embodiment of the present invention.

FIG. 4 is a schematic plan view (a first step) in the course of the production process of an organic EL display involved in an embodiment of the present invention.

FIG. 5 is a schematic plan view (a second step) in the course of the production process of an organic EL display involved in an embodiment of the present invention.

FIG. 6 is a schematic plan view (a third step) in the course of the production process of an organic EL display involved in an embodiment of the present invention.

FIG. 7 is a schematic plan view (a fourth step) in the course of the production process of an organic EL display involved in an embodiment of the present invention.

FIG. 8 is a schematic plan view of a pixel of an organic EL display involved in an embodiment of the present invention.

FIG. 9 is a diagram showing the relative area ratios of the four subpixels arranged in a pixel of an organic EL display formed in an embodiment of the present invention.

FIG. 10 is a table showing the gradation variation generated by the combinations of the emission conditions of the subpixels.

### BEST MODE FOR CARRYING OUT THE INVENTION

Description will be made below of the embodiments involved in the present invention on the basis of the accompanying drawings.

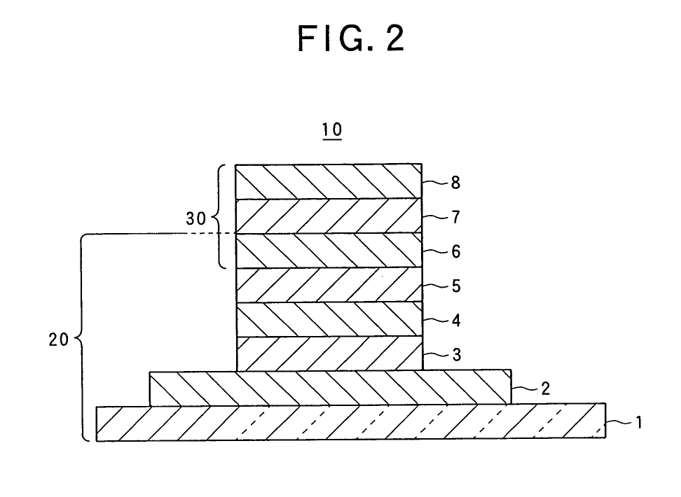

FIG. 2 is a schematic sectional view of an organic EL element laminate type organic switching element involved in an embodiment.

As FIG. 2 shows, the organic EL element laminate type organic switching element 10 has a configuration in which an organic EL element part 20 and an organic switching element part 30 are laminated on each other.

The organic EL element part 20 has (comprises) a transparent substrate 1 such as a glass substrate and the following things laminated in order thereon: a transparent electrode 2 (the anode of the organic EL element part 20), a positive hole transport layer 3 made of an organic compound, an emission layer 4 made of an organic compound, an electron transport layer 5 made of an organic compound, and a control electrode 6 (the cathode of the organic EL element part 20). Incidentally, the positive hole transport layer 3 includes an injection layer and a transport layer, and these two layers maybe respectively made of different organic compounds, while the electron transport layer 5 also includes an injection layer and a transport layer, and these two layers may be respectively made of different organic compounds.

The organic switching element part 30 has (comprises) a control electrode 6 (the anode of the organic switching element part 30), an operating layer 7 made of an organic compound or an laminate of a metal and an organic compound, and a metallic electrode 8 (the cathode of the organic switching element part 30).

The material for the operating layer 7 includes the following materials but is not limited thereto: a mixture of Cu (or other metals) and TCNQ (and the analogs thereof), alaminate structure made of AlDCN and Al, a laminate structure made of an organic matter containing positive and negative polar substituents and a metal, an organometallic complex and the like.

Incidentally, the above described organic switching element part 30 is similar both in structure and in the current-voltage characteristics to an organic bistable element (OBD: Organic bistable device) described in a paper, “Liping Ma, Jie Liu, Seungmoon Pyo, and Yang Yang, Applied Physics Letters, Vol. 80, No. 3, 21 Jan. 2002.”

The organic EL laminate type organic switching element involved in the present embodiment is characterized in that the switching element is provided with the control electrode 6 to which is electrically connected the control signal line for the emission/nonemission control of the organic EL element part 20. Furthermore, the above described control electrode 6 works also both as the cathode of the organic EL element part 20 and as the anode of the organic switching element part 30.

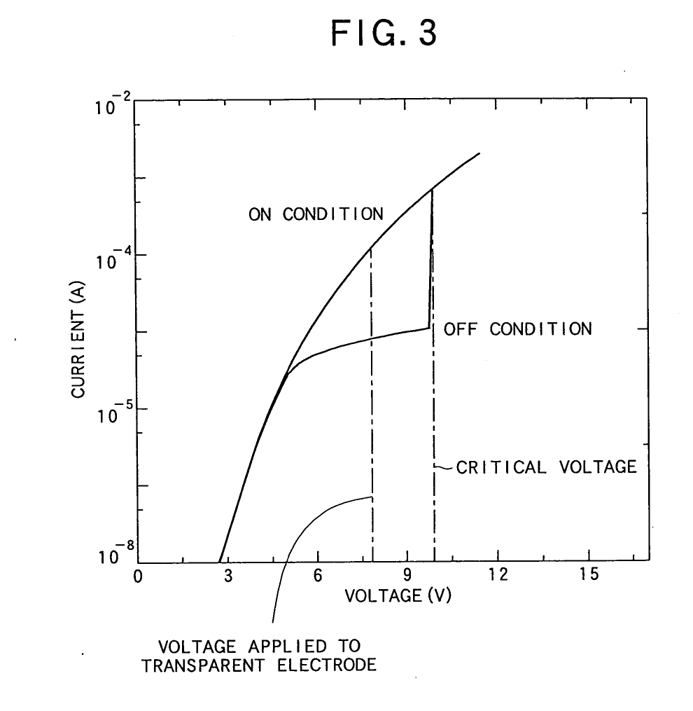

FIG. 3 shows the current-voltage characteristics of the organic EL laminate type organic switching element 10.

As can be seen from FIG. 3, the current-voltage characteristics show that a high resistance condition is maintained until a critical voltage (about 10 V in FIG. 3) is applied, while once the applied voltage exceeds the critical voltage, a low resistance condition is attained, and the low resistance condition can be maintained in a time-independent manner. Additionally, application of a negative voltage permits returning from the low resistance condition to the high resistance condition.

The organic EL display involved in the present embodiment has pixels each of which is divided into at least two subpixels, and the above described organic EL laminate type organic switching element 10 is used for each of the subpixels.

As described above, the organic EL display involved in the present embodiment has the configuration in which an organic EL laminate type organic switching element 10 is arranged in each subpixel, and hence can conduct the emission/nonemission control for every subpixel and permits displaying gradation through varying the emission area in each pixel.

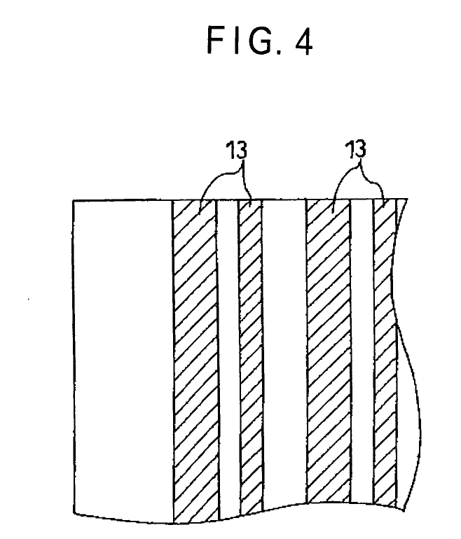

Now, description will be made of forming the organic EL display in which pixels are the organic EL laminate type organic switching elements involved in the present embodiment, through citing an embodiment comprising the steps (1) to (8) with reference to the schematic plan views shown in FIGS. 4 to 8.

(1) Process for Forming ITO (Indium-tin Oxide) Pattern

An ITO layer of 1,000 Å in thickness is formed by sputtering on a glass substrate (transparent substrate 1) in such a way that the ITO lines 13 (the transparent electrodes 2 as the anodes for the organic EL element parts) are formed by patterning so as for the ITO lines to be partitioned with a ratio of 4:1 per one pixel (see FIG. 4).

(2) Process for Forming Control Signal Lines

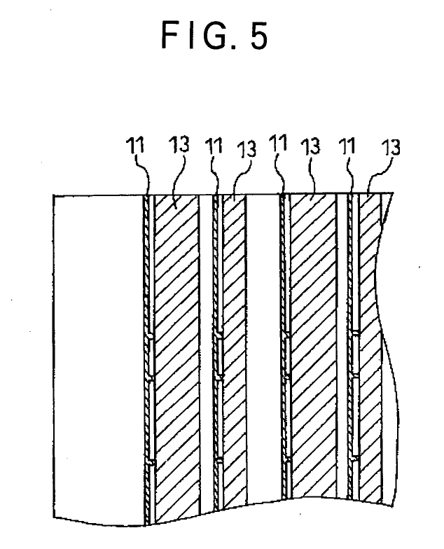

Cr lines of 1,500 Å in thickness are formed by sputtering as the control signal lines 11 of the organic EL emission parts 12 (the subpixel emission parts) in such a way that the control signal lines 11 are parallel to the ITO lines 13 (see FIG. 5).

(3) Process for Forming Insulating Film

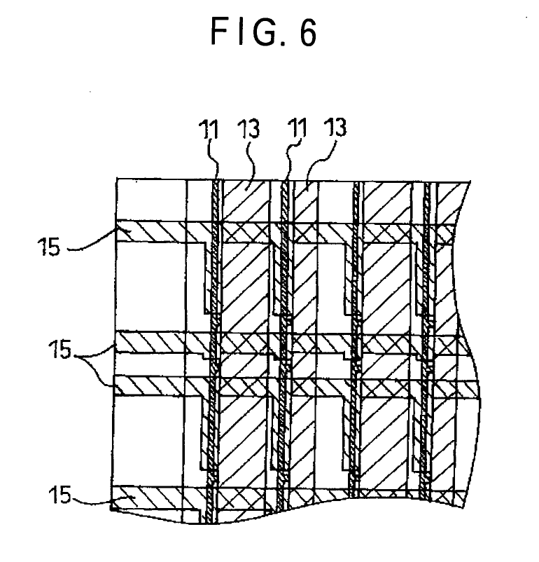

For the purpose of preventing current leak, polyimide insulating film strips of 5,000 Å in thickness are formed on the relevant portions in such a way that the insulating film strips 15 are formed by patterning (see FIG. 6).

(4) Process for Forming Cathode Partition Walls

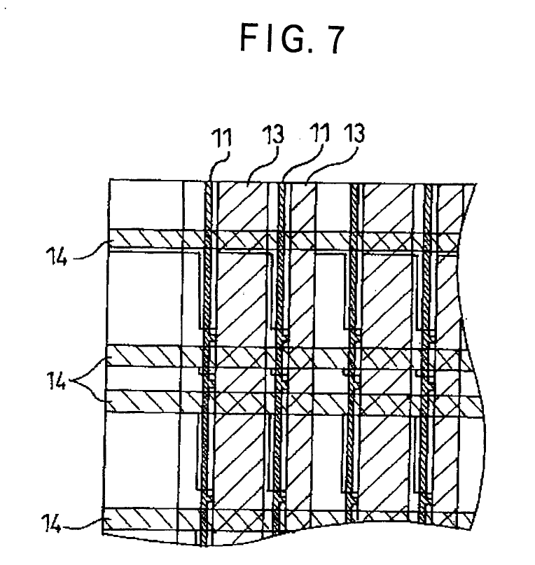

Cathode partition walls 14 are formed for the purpose of patterning the cathodes in arbitrary shapes (see FIG. 7).

(5) Process for Forming Organic EL Film

The organic EL element parts 20 are formed as film by the vacuum deposition method. CuPC, NPB, Al₂O₃ and LiF are utilized for the positive hole injection layer, the positive hole transport layer 3, the emission layer 4 and the electron injection layer (electron transport layer 5), respectively. In this process, the film formation area is limited by use of a pattern mask (see FIG. 2).

(6) Process for Forming Control Electrode Film

An Al film is formed as the control electrodes 6 by the vacuum deposition. In this process, the film formation area is limited by use of a pattern mask, and satisfactory electric connection to the control signal lines 11 is attained (see FIG. 2).

(7) Process for Forming Film in the Organic Switching Element Part

As the operating layer 7 of the organic switching element part 30, AlDCN, Al and AlDCN are vacuum deposited as films in this order in the thickness values of 500 Å, 300 Å and 800 Å, respectively. In this process, the film forming area is limited by use of a pattern mask; for all the above described three steps of deposition, one and the same mask is used (see FIG. 2).

(8) Process for Forming Film for Cathodes

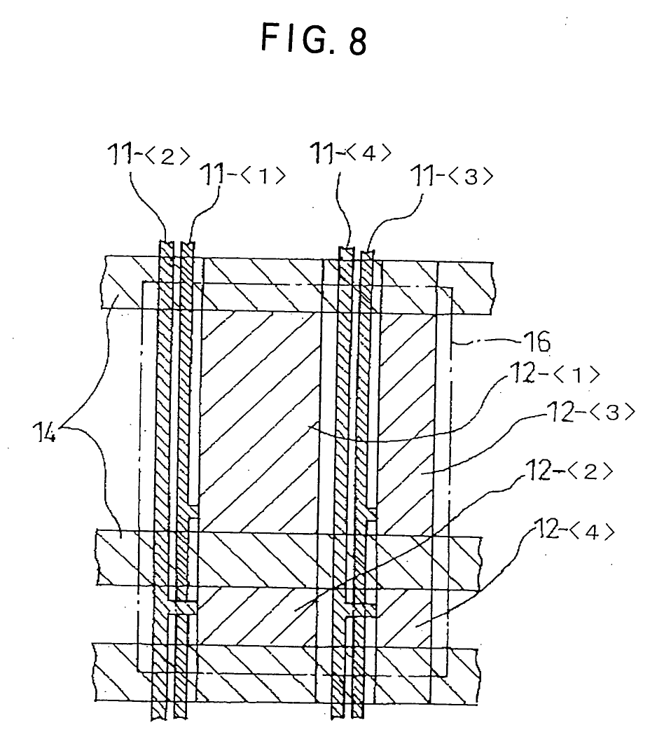

Finally, Al is vacuum deposited as film in the thickness of 1,000 Å, as the metallic electrode 8 of the cathode for the organic switching element part 30. In this process, pattern formation is performed with the aid of the cathode partition walls 14, but without using a mask (see FIG. 8).

FIG. 8 shows a schematic plan view of the pixels of the organic EL display formed by the above described processes (1) to (8)

As FIG. 8 shows, one pixel 16 of the organic EL display is a portion circumscribed by a dashed line. The one pixel is dividedinto four subpixels 12 (12-<1>, 12-<2>, 12-<3>, 12-<4>); and the control signal lines 11 (11-<1>, 11-<2>, 11-<3>, 11-<4>) are electrically connected to the control electrodes 6 of the subpixels.

In this way, the emission/nonemission condition of each subpixel can be controlled by independently controlling each of the control signal lines, 11-<1>, 11-<2>, 11-<3>, 11-<4>.

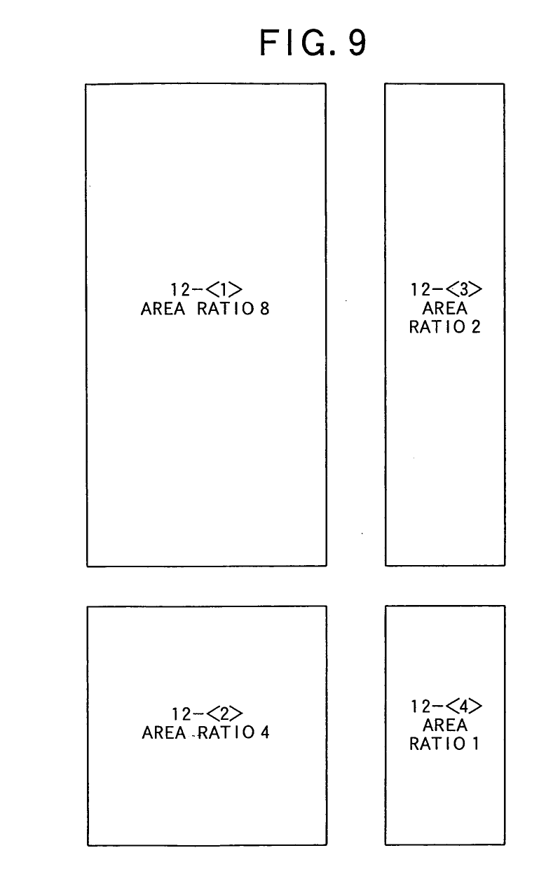

The area ratio between the four subpixels, 12-<1>, 12-<2>, 12-<3>, 12-<4>, shown in FIG. 8, arranged in one pixel of the organic EL display formed in the above described embodiment is 8:4:2:1 as shown in FIG. 9.

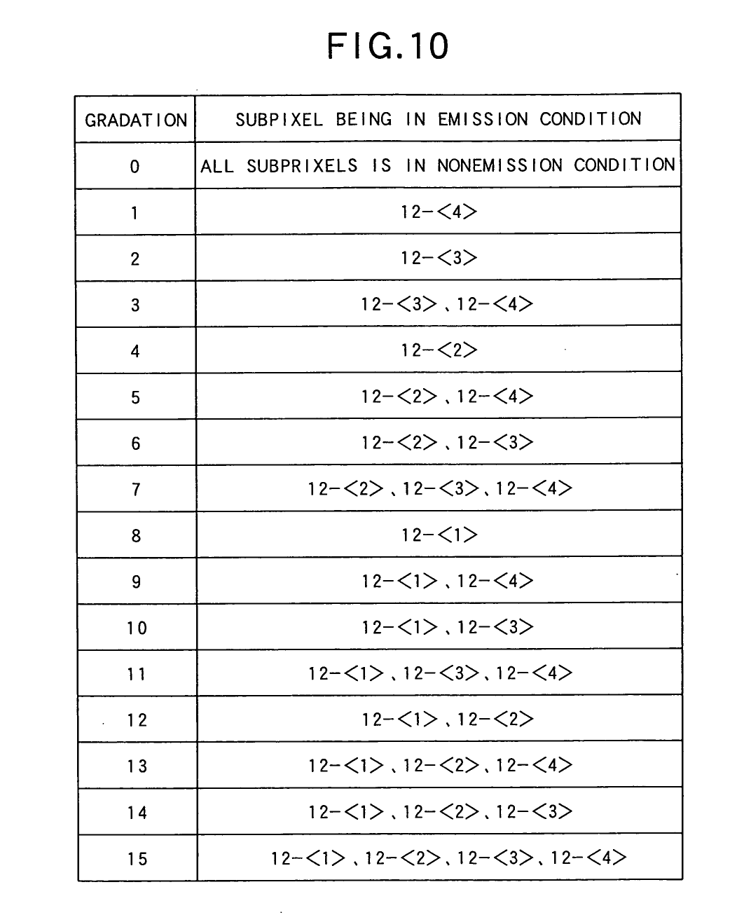

Combination of the emission/nonemission conditions of the subpixels, 12-<1>, 12-<2>, 12-<3>, 12-<4>, permits varying the emission area of the whole pixel so that the gradation of the pixel can be displayed (the gradation of the pixel can be represented). FIG. 10 is a table showing the gradation variation generated by the combinations of the emission conditions of the subpixels.

As the table of FIG. 10 shows, the darkest display is achieved with all the subpixels being in the nonemission condition (gradation 0); the brightness of gradation 1 is obtained with only the subpixel 12-<4>being in the emission condition; the brightness of gradation 2 is obtained with only the subpixel 12-<3>being in the emission condition; and the other gradations 3 through 15 can be obtained with the varied combinations of the subpixel emission conditions as specified successively in FIG. 10.

Incidentally, the time duration control of the emission/nonemission conditions of the subpixels 12-<1>, 12-<2>, 12-<3>, 12-<4>makes it possible to achieve an even more larger number of gradations.

Now, description is made with reference to an example of the drive method for specifying the emission/nonemission conditions of the above described subpixels. In any case, a voltage of 8 V is constantly applied to the ITO electrode (the voltage for maintaining the emission of the organic EL laminate type organic switching element; see the current-voltage characteristics shown in FIG. 3).

Switchover from the nonemission condition to the emission condition is carried out as follows: an instantaneous voltage of the order of +5 V is applied between the control electrode and cathode of the subpixel being specified to emit light, and immediately thereafter the control electrode is made open.

On the other hand, switchover from the emission condition to the nonemission condition is carried out as follows: an instantaneous voltage of the order of −5 V is applied between the control electrode and cathode of the subpixel being specified to emit no light, and immediately thereafter the control electrode is made open.

Incidentally, when no switchover between the emission condition and the nonemission condition is intended to be carried out, it suffices that the condition is maintained in which the voltage of 8 V is being applied to the ITO electrode.

Now, description is made below with reference to a modified example of the embodiment.

In the above described embodiment, the via holes are formed as the contact points between the control signal lines and the control electrodes by patterning the insulating film; however, the formation of the control electrodes and the formation of the control signal lines may be carried out simultaneously.

In the above described embodiment, the emission area ratio is specified to be 8:4:2:1; however, any other arbitrary ratios can be specified.

In the above described embodiment, one pixel is divided into four subpixels; however, the division number can take any integer not smaller than 2.

Furthermore, the gradation display (gradation representation) method may rely either solely on the emission area control or on the combination of the emission area control with the time duration control of the emission such as the subframe modulation.

The organic EL display involved in the present embodiment permits achieving easily an organic EL display of the active matrix drivemode by utilizing the organic EL laminate type organic switching element.

When compared with conventional organic EL displays of the active matrix drive mode, the above mentioned organic EL display of the active matrix drive mode permits reducing the production cost owing to the production easiness thereof. Incidentally, an organic EL display of the active matrix drive mode is able to achieve the longer operation life and lower consumption of electric power, as compared with passively driven organic EL displays.

The process temperature is as low as room temperature for the production of the organic EL laminate type organic switching element involved in the present embodiment, and accordingly the organic EL laminate type organic switching element involved in the present embodiment can be easily formed even on a substrate other than glass substrates (plastic substrates or the like).

Additionally, the organic EL display involved in the present embodiment can accommodate a larger open area ratio as compared to conventional organic EL displays of the active matrix drive mode based on the MOS type TFT's.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

All the disclosures in the Japanese Patent Application (No. 2002-285022) filed on Sep. 30, 2002, including its specification, claims, drawings and abstract, are hereby incorporated by reference into this application in its entirety.

1. (canceled)

2. The organic EL display according to claim 5, wherein the control electrode serves both as a cathode of the organic EL element part and as an anode of the organic switching element part.

3. An organic EL display, wherein an image plane is composed of a plurality of pixels and the pixels each have two or more subpixels, and
wherein the two or more subpixels have emission areas, which have sizes that are different from each other.

4. (canceled)

5. The organic EL display according to claim 3, wherein the subpixels each are constructed with an organic EL laminate type organic switching element in which an organic EL element part and an organic switching element part are laminated on each other, and a control electrode is provided to which a control signal line for controlling an emission/nonemission condition of the organic EL element part is electrically connected.

6. The organic EL display according to claim 5, wherein the display is constructed in such a way that the two or more subpixels are supplied with control signals different from each other so that the gradation display of the pixel is made possible.

7. The organic EL display according to claim 3, wherein an emission area of the pixel including the two or more subpixels is varied by controlling emission/nonemission conditions of the two or more subpixels.

8. An organic EL display comprising a plurality of pixels, wherein each of the pixels has at least a first subpixel and a second subpixel,
wherein the first subpixel has an emission area having a first size, and
wherein the second subpixel has an emission area having a second size, which is different than the first size.

9. The organic EL display according to claim 8, wherein each of the first subpixel and the second subpixel is formed of an organic EL laminate type organic switching element, which comprises:
an organic EL element;
an organic switching element which is laminated on the organic EL element; and
a control electrode, which is electrically connected to a control signal line for controlling an emission/nonemission condition of the organic EL element.

10. The organic EL display according to claim 9, wherein the first subpixel and the second subpixel of each of the pixels are supplied with different control signals to make a gradation display of each of the pixels.

11. The organic EL display according to claim 8, wherein an emission area of each of the pixels is varied by controlling emission/nonemission conditions of the first subpixel and the second subpixel of each of the pixels.
